(19) United States
(12) Patent Application Publication
(10) Pub. No.: US 2026/0276225 A1
(43) Pub. Date: Sep. 17, 2026

(54) AIR CONDITIONER

(71) Applicant: SAMSUNG ELECTRONICS CO., LTD., Suwon-si (KR)

(72) Inventors: Joonoh SHIN, Suwon-si (KR); Myungsoo KANG, Suwon-si (KR); Sangmo KANG, Suwon-si (KR); Hyongsoo NOH, Suwon-si (KR)

(73) Assignee: SAMSUNG ELECTRONICS CO., LTD., Suwon-si (KR)

(21) Appl. No.: 19/652,251

(22) Filed: Apr. 20, 2026

Related U.S. Application Data
(63) Continuation of application No. PCT/KR2024/018082, filed on Nov. 15, 2024.

(30) Foreign Application Priority Data
Dec. 12, 2023 (KR) 10-2023-0179962
Mar. 15, 2024 (KR) 10-2024-0036532

(51) Int. Cl. F24F 8/192; B03C 3/011; B03C 3/08; B03C 3/36; B03C 3/41; B03C 3/47; B03C 3/68

(52) U.S. Cl. CPC F24F 8/194; B03C 3/011; B03C 3/08; B03C 3/366; B03C 3/41; B03C 3/47; B03C 3/68

(57) ABSTRACT

An air conditioner includes a blowing fan, a housing to accommodate the blowing fan, the housing including a first surface, a second surface, a third surface, a fourth surface, an intake port formed on the first surface, the second surface, the third surface, and the fourth surface, and an electrostatic precipitator accommodated in the housing. The electrostatic precipitator includes a dust collecting electrode configured to capture aerosols from air introduced into the housing by the blowing fan, a discharging electrode configured to generate ions toward the intake port and positioned upstream of the dust collecting electrode, an electric field induction electrode grounded to form an electric field with the discharging electrode and positioned upstream of the discharging electrode, and a grounding electrode positioned downstream of the discharging electrode and upstream of the dust collecting electrode so that the ions are attached thereto.

### CROSS REFERENCE TO THE RELATED APPLICATION

This application is a continuation application, filed under 35 U.S.C. § 111 (a), of International Application PCT/KR2024/018082 filed on Nov. 15, 2024, and is based on and claims priority under 35 U.S.C. § 119 to Korean Patent Applications No. 10-2023-0179962, filed on Dec. 12, 2023, and Korean Patent Applications No. 10-2024-0036532, filed on Mar. 15, 2024, in the Korean Intellectual Property Office, the disclosures of which are incorporated by reference herein in their entireties.

### TECHNICAL FIELD

The present disclosure relates to an air conditioner, and more particularly, to an air conditioner including an electrostatic precipitator.

### BACKGROUND ART

High concentrations of aerosols in closed spaces such as homes, rooms, shopping malls, factories, and offices may harm health of people. These aerosols may be generated in confined spaces by smoking, cooking, cleaning, welding, grinding, etc.

An electrostatic precipitator may be used in an air conditioner having an air purification function as a device for removing such aerosols.

An electrostatic precipitator may include a charging part for charging aerosols in the air through discharge, and a dust collecting part composed of a high-voltage electrode and a low-voltage electrode for collecting the aerosols charged by the charging part.

### DISCLOSURE

### Technical Problem

The present disclosure is directed to providing an air conditioner with improved esthetic sensibility.

The present disclosure is directed to providing an air conditioner with improved dust collection efficiency.

Technical tasks to be achieved in the present disclosure are not limited to the technical tasks mentioned above, and other technical tasks not mentioned will be clearly understood by those skilled in the art to which the present disclosure belongs from the fallowing description.

### Technical Solution

An air conditioner according to an embodiment of the present disclosure may include: a blowing fan configured to form an air flow; a housing configured to accommodate the blowing fan and including a first surface, a second surface opposite the first surface, a third surface between the first surface and the second surface, and a fourth surface opposite the third surface between the first surface and the second surface, the housing having an intake port formed on the first surface, the second surface, the third surface, and the fourth surface; and an electrostatic precipitator accommodated in the housing, wherein the electrostatic precipitator may include: a dust collecting electrode configured to capture aerosols from air introduced into the housing by the blowing fan; a discharging electrode configured to generate ions toward the intake port and positioned upstream of the dust collecting electrode; an electric field induction electrode grounded to form an electric field with the discharging electrode and positioned upstream of the discharging electrode; and a grounding electrode positioned downstream of the discharging electrode and upstream of the dust collecting electrode so that the ions are attached thereto.

The grounding electrode may be a first grounding electrode, the discharging electrode may be disposed above the electric field induction electrode and below the first grounding electrode, and the electrostatic precipitator may further comprise a second grounding electrode disposed below the electric field induction electrode.

At least one of the first grounding electrode and the second grounding electrode may comprise a first extension part extending in a first direction and a second extension part extending to intersect the first extension part to form a mesh shape with the first extension part.

At least one of the first grounding electrode and the second grounding electrode may comprise a plate part, and a plurality of holes formed on the plate part to allow the air introduced into inside of the housing by the blowing fan to pass through, the plurality of holes having at least one of a polygon and a circle.

The discharging electrode may comprise a plurality of discharging electrodes, the electrostatic precipitator may comprise a plurality of printed circuit boards configured to be electrically connected to the plurality of discharging electrodes, and the plurality of printed circuit boards may comprise a first printed circuit board extending in a first direction, and a second printed circuit board extending in the first direction, the second printed circuit board spaced apart from the first printed circuit board in a second direction different from the first direction.

The plurality of printed circuit boards may further comprise a third printed circuit board extending in the second direction to connect the first printed circuit board and the second printed circuit board.

The third printed circuit board may be connected to a first end of the second printed circuit board along the first direction, and the plurality of printed circuit boards may further comprise a fourth printed circuit board connected to a second end of the second printed circuit board along the first direction.

The discharging electrode may comprise a plurality of the discharging electrodes,

The electrostatic precipitator may comprise a plurality of printed circuit boards configured to be electrically connected to the plurality of discharging electrodes, and the plurality of printed circuit boards may comprise a first printed circuit board comprising a first board part extending in a first direction and a second board part extending from one end of the first board part in a second direction different from the first direction and a second printed circuit board comprising: a first board part extending in the first direction; and a second board part extending from one end of the first board part in a third direction opposite to the second direction.

The discharging electrode may comprise a plurality of discharging electrodes, the electrostatic precipitator may comprise a printed circuit board configured to be electrically connected to the plurality of discharging electrodes, and the printed circuit board may comprise a first board part extending in a first direction, a second board part spaced apart from the first board part, the second board part extending in the first direction, a third board part extending in a second direction to connect the first board part and the second board part, and a fourth board part spaced apart from the third board part, the fourth board extending in the second direction to connect the first board part and the second board part.

The electric field induction electrode may comprise a horizontal portion disposed below the discharging electrode; and a protrusion portion protruding from the horizontal portion toward the discharging electrode.

The discharging electrode may comprise a plurality of discharging electrodes, the electric field induction electrode may be configured to surround the plurality of discharging electrodes, the electric field induction electrode may comprise a first side, a second side spaced apart from the first side, a third side connecting the first side and the second side between the first side and the second side; and a fourth side being open between the first side and the second side, the electrostatic precipitator may comprise a plurality of printed circuit boards configured to be electrically connected to the plurality of discharging electrodes, and the plurality of printed circuit boards may comprise a first printed circuit board adjacent to the first side of the electric field induction electrode, the first printed circuit board extending in a first direction; a second printed circuit board spaced apart from the first printed circuit board to be adjacent to the second side of the electric field induction electrode, the second printed circuit board extending in the first direction, and a third printed circuit board adjacent to the third side of the electric field induction electrode, the third printed circuit board extending in a second direction different from the first direction.

The electric field induction electrode may comprise an annular shape.

An air conditioner according to an embodiment of the present disclosure may include: a housing; a blowing fan disposed inside the housing and configured to introduce it in to the housing; and an electrostatic precipitator accommodated in the housing, wherein the electrostatic precipitator may include: a dust collecting electrode configured to capture aerosols from air introduced into the housing by the blowing fan; a discharging electrode configured to generate ions and positioned below the dust collecting electrode; a first grounding electrode grounded to form an electric field with the discharging electrode and positioned below the discharging electrode; and a second grounding electrode positioned above the discharging electrode and below the dust collecting electrode so that the ions are attached thereto.

The discharging electrode may be disposed above the first grounding electrode and below the second grounding electrode, and the electrostatic precipitator may further comprise a third grounding electrode disposed below the first grounding electrode.

At least one of the second grounding electrode and the third grounding electrode may comprise a first extension part extending in a first direction and a second extension part extending to intersect the first extension part to form a mesh shape with the first extension part.

An air conditioner according to an embodiment of the present disclosure may include: a blowing fan; a housing configured to accommodate the blowing fan, including a first side, a second side opposite the first side, a third side between the first side and the second side, and a fourth side opposite the third side between the first side and the second side, and having a plurality of intake ports formed on each of the first side, the second side, the third side, and the fourth side; and an electrostatic precipitator accommodated in the housing, wherein the electrostatic precipitator may include: a dust collecting electrode configured to capture aerosols from air introduced into the housing by the blowing fan; a discharging electrode configured to generate ions toward the plurality of intake ports and positioned below the dust collecting electrode; an electric field induction electrode grounded to form an electric field with the discharging electrode and positioned below the discharging electrode; and a grounding electrode positioned above the discharging electrode and below the dust collecting electrode.

### Advantageous Effects

According to an aspect of the present disclosure, an air conditioner having improved aesthetic sensibility can be provided because a discharging electrode is not exposed.

According to an aspect of the present disclosure, an air conditioner can be provided in which charging efficiency of aerosols in a charging part is improved because a dust collecting electrode is provided.

Effects according to the present disclosure are not limited to the effects mentioned above, and other effects not mentioned will be clearly understood by those skilled in the art to which the present disclosure belongs from the fallowing description.

### DESCRIPTION OF DRAWINGS

FIG. 1 is a perspective view of an air conditioner according to an embodiment.

FIG. 2 is an enlarged view of the air conditioner according to an embodiment.

FIG. 3 is a cross-sectional view of the air conditioner according to an embodiment.

FIG. 4 is an enlarged view of the air conditioner according to an embodiment.

FIG. 5 is an exploded perspective view of the air conditioner according to an embodiment.

FIG. 6 is a schematic view of the air conditioner according to an embodiment.

FIG. 7 is a schematic view of the air conditioner according to an embodiment.

FIG. 8 is a schematic view of the air conditioner according to an embodiment.

FIG. 8B is a schematic view of the air conditioner according to an embodiment.

FIG. 8C is a schematic view of the air conditioner according to an embodiment.

FIG. 8D is a schematic view of the air conditioner according to an embodiment.

FIG. 9A is a schematic view of the air conditioner according to an embodiment.

FIG. 9B is a schematic views of the air conditioner according to an embodiment.

FIG. 9C is a schematic views of the air conditioner according to an embodiment.

FIG. 9D is a schematic views of the air conditioner according to an embodiment.

FIG. 10A is a schematic view of the air conditioner according to an embodiment.

FIG. 10B is a schematic views of the air conditioner according to an embodiment.

FIG. 11A is a schematic view of the air conditioner according to an embodiment.

FIG. 11B is a schematic views of the air conditioner according to an embodiment.

FIG. 12A is a schematic view of the air conditioner according to an embodiment.

FIG. 12B is a schematic views of the air conditioner according to an embodiment.

FIG. 12C is a schematic views of the air conditioner according to an embodiment.

FIG. 13A is a schematic view of the air conditioner according to an embodiment.

FIG. 13B is a schematic views of the air conditioner according to an embodiment. FIG. 14A is a schematic view of the air conditioner according to an embodiment.

FIG. 14B is a schematic views of the air conditioner according to an embodiment.

FIG. 14C is a schematic views of the air conditioner according to an embodiment.

FIG. 15 is a schematic view of the air conditioner according to an embodiment.

FIG. 16A is a schematic view of the air conditioner according to an embodiment.

FIG. 16B is a schematic views of the air conditioner according to an embodiment.

FIG. 17 is a schematic view of the air conditioner according to an embodiment.

FIG. 18 is a cross-sectional view of the air conditioner according to an embodiment.

FIG. 19 is an enlarged view of the air conditioner according to an embodiment.

FIG. 20 is an exploded perspective view of the air conditioner according to an embodiment.

FIG. 21 is a schematic view of the air conditioner according to an embodiment.

FIG. 22 is a schematic view of the air conditioner according to an embodiment.

### MODE OF THE DISCLOSURE

The embodiments described in the present disclosure and the configurations shown in the drawings are only examples of preferred embodiments of the present disclosure, and various modifications may be made at the time of filing of the present disclosure to replace the embodiments and drawings of the present disclosure.

The same reference numbers or symbols presented in each drawing of the present disclosure represent parts or components that perform substantially the same functions.

The terms used herein are for the purpose of describing the embodiments and are not intended to restrict and/or to limit the present disclosure. For example, the singular expressions herein may include plural expressions, unless the context clearly dictates otherwise. Also, the terms “includes” and “has” are intended to indicate that there are features, numbers, steps, operations, components, parts, or combinations thereof described in the specification, and do not exclude the presence or addition of one or more other features, numbers, steps, operations, components, parts, or combinations thereof.

In the present disclosure, each of phrases such as “A or B,” “at least one of A and B,” “at least one of A or B,” “A, B or C,” “at least one of A, B and C,” and “at least one of A, B, or C” may include any one of the items listed together in the corresponding one of the phrases, or all possible combinations thereof.

The term “and/or” includes any combination of a plurality of related components or any one of a plurality of related components.

Terms including ordinal numbers, such as “first,” “second,” etc., used in the present disclosure may be used to describe various components, but the components are not limited by the terms, and the terms are used only for the purpose of distinguishing one component from another. For example, without departing from the scope of the present disclosure, a first component may be referred to as a second component, and similarly, a second component may also be referred to as a first component. The term “and/or” includes any combination of a plurality of related listed items or any one of a plurality of related listed items.

In the present disclosure, the meaning of “identical” includes things that have similar properties or are similar within a certain range. Additionally, “identical” means “substantially identical.” “Substantially identical” should be understood to include values that fall within a manufacturing margin of error or that differ from a reference value by a nonsensical amount.

Terms such as “~unit,” “~part,” “~block,” “~member,” “~module,” and the like may denote a unit for processing at least one function or operation. For example, the terms may refer to at least one hardware such as a field-programmable gate array (FPGA)/an application specific integrated circuit (ASIC), at least one software stored in memory, or at least one process processed by a processor.

The terms “front,” “rear,” “left side,” “right side,” and the like used in the present disclosure are defined based on the drawings, and the shape and position of each component are not limited by these terms.

An electrostatic precipitator is a device for removing aerosols in the air generated by an activity such as smoking, cooking, cleaning, welding, grinding, and operating an internal combustion engine within a certain space. An electrostatic precipitator may be installed inside a device capable of performing an air filtering function, such as an air conditioner.

For convenience of explanation, an air purifier, which is a type of air conditioner, is described below as an example, but the present disclosure is not limited to air purifiers and may also be applied to other air conditioners for capturing aerosols in the air. For example, the present disclosure may also be applied to cooling and heating devices, which are a type of air conditioner other than an air purifier. Furthermore, the present disclosure may be applied to any home appliance as long as the home appliance includes an electrostatic precipitator.

Hereinafter, embodiments of the present disclosure will be described in detail with reference to the accompanying drawings.

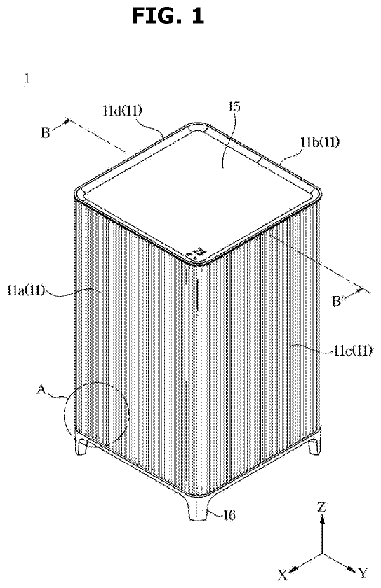

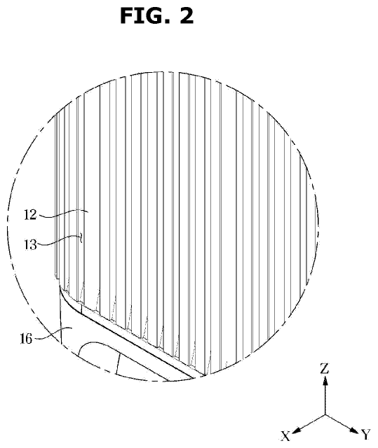

FIG. 1 is a perspective view of an air conditioner according to an embodiment. FIG. 2 is an enlarged view of the air conditioner according to an embodiment. FIG. 2 is an enlarged view of area A shown in FIG. 1.

Referring to FIGS. 1 and 2, an air conditioner 1 may include a housing 10. The housing 10 may form an outer appearance of the air conditioner 1.

The housing 10 may include an upper panel 15. The upper panel 15 may be provided on an upper end of the housing 10. The upper panel 15 may be disposed above a blowing panel 11. A user display may be provided on the upper panel 15. For example, the user display may include a manipulation part. The user display may receive user input or output operation information of the air conditioner 1 to a user.

The housing 10 may include a support 16. The support 16 may be disposed at a lowermost side of the housing 10 to support components constituting the housing 10 and the air conditioner 1.

The housing 10 may include the blowing panel 11. The blowing panel 11 may include a first panel 11a, a second panel 11b, a third panel 11c, and a fourth panel 11d. The first panel 11a may form a front side of the air conditioner 1, the second panel 11b may form a rear surface of the housing 10, and the third panel 11c and the fourth panel 11d may form side surfaces of the housing 10. The third panel 11c and the fourth panel 11d may connect the first panel 11a and the second panel 11b. The first panel 11a may be a front panel, the second panel 11b may be a rear panel, the third panel 11c may be a left panel, and the fourth panel 11d may be a right panel. The first panel 11a, the second panel 11b, the third panel 11c and the fourth panel 11d may be formed integrally.

The blowing panel 11 may include a panel part 12 and a blowing port 13.

The panel part 12 may include a plurality of ribs. The plurality of ribs may extend in one direction. For example, the plurality of ribs may extend in an up-down direction. However, the present disclosure is not limited thereto.

The panel part 12 may be formed over the entire area of the blowing panel 11. The blowing panel 11 may be provided to expose a discharging electrode 61 (see FIG. 2) inside the housing 10 to the outside without a separately formed hole. For example, the panel part 12 may be provided with a uniform pattern over the entire area of the blowing panel 11. This increases a freedom of design of the blowing panel 11 to improve aesthetic sensibility.

The blowing port 13 may be formed to correspond to the panel part 12. For example, the blowing port 13 may be an opening formed between the plurality of ribs of the panel part 12. Air outside the housing 10 may be drawn into the housing 10 or exhausted from the housing 10 through the blowing port 13. The blowing port 13 may include a plurality of openings.

The air conditioner 1 may include the blowing port 13. For example, the blowing panel 11 may be formed with a blowing port 13 to allow outside air to be introduced into and exhausted from the inside of the air conditioner 1. The blowing port 13 may extend in the up-down direction. The blowing port 13 may be formed in plurality. A plurality of the blowing ports 13 may be arranged in a direction perpendicular to the up-down direction. For example, the plurality of blowing ports 13 may be arranged in a left-right direction or in a front-rear direction.

Air blown through a blowing fan 30 may pass through the blowing port 13. The blowing port 13 may include a first intake port 13a and an exhaust port 13b. The first intake port 13a may be positioned upstream of the exhaust port 13b. The exhaust port 13b may be positioned downstream of the first intake port 13a. Air may pass through the housing 10. Air flowed into the housing 10 through the first intake port 13a may pass through the blowing fan 30 and flow out of the housing 10 through the exhaust port 13b.

The first intake port 13a may be provided below the exhaust port 13b. The exhaust port 13b may be provided above the first intake port 13a. However, the positions of the first intake port 13a and the exhaust port 13b are not limited to the above-described example.

The first intake port 13a and the exhaust port 13b may be formed in each of the first panel 11a, the second panel 11b, the third panel 11c, and the fourth panel 11d. For example, the first intake port 13a and the exhaust port 13b may be formed on front, rear, left, and right surfaces of the housing 10.

For example, air outside the housing 10 may flow into the housing 10 from four directions through the first intake ports 13a. For example, air outside the housing 10 may flow into the housing 10 from all directions through the first intake ports 13a. Also, for example, air inside the housing 10 may flow out of the housing 10 in four directions through the exhaust ports 13b. For example, air inside the housing 10 may flow out of the housing 10 in all directions through the exhaust ports 13b.

Therefore, because air is drawn in from all directions, air circulation inside the housing 10 may be performed smoothly, so that the electrostatic precipitator and the air conditioner including the same may achieve high dust collection efficiency.

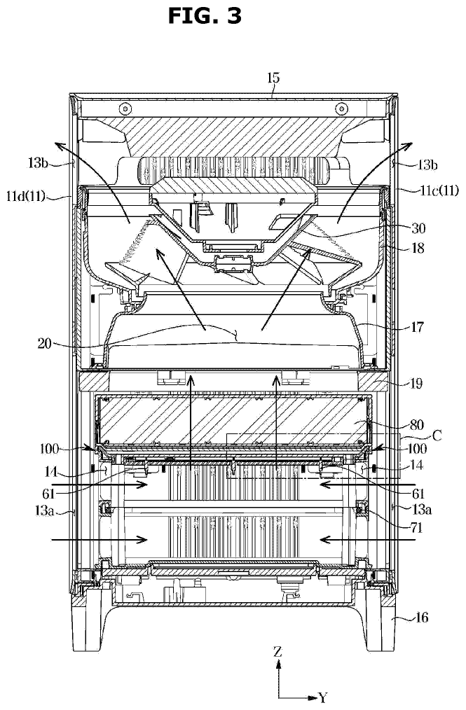

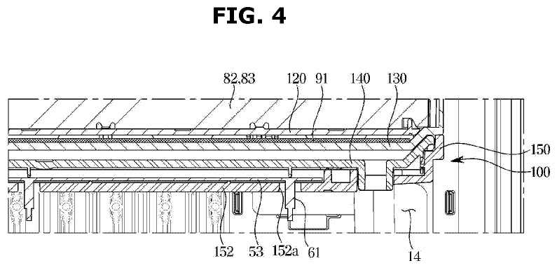

FIG. 3 is a cross-sectional view of the air conditioner according to an embodiment. FIG. 4 is an enlarged view of the air conditioner according to an embodiment. FIG. 5 is an exploded perspective view of the air conditioner according to an embodiment.

FIG. 3 is a cross-sectional view cut along line B-B′ shown in the air conditioner of FIG. 1. FIG. 4 is an enlarged view of area C shown in FIG. 3.

Referring to FIGS. 3 to 5, the air conditioner 1 may include the blowing fan 30. The blowing fan 30 may be positioned downstream of the first intake port 13a and upstream of the exhaust port 13b. The blowing fan 30 may be positioned in an upper portion inside the housing 10. The blowing fan 30 may rotate to generate a flow of air flowing inside the housing 10.

Air may pass through the housing 10 along an air flow direction. The air flow direction may be a direction of directing from upstream to downstream of an air flow path 20. The air flow direction may be a direction in which air is introduced into the housing 10 through the first intake port 13a and a second intake port 14, passes through an electrostatic precipitator 50 and the blowing fan 30, and then flows toward the exhaust port 13b. For example, the air flow direction may be a direction in which air is introduced into the housing 10 through the first intake port 13a and the second intake port 14, changes direction at a predetermined angle, and then passes through the electrostatic precipitator 50 and the blowing fan 30. For example, air drawn into the front, rear, left, and right sides of the housing 10 by the blowing fan 30 may flow upward and then be exhausted again into the front, rear, left, and right sides of the housing 10. However, the air flow direction is not limited to the above examples.

The housing 10 may include an air guide 17. Air flowed into the housing 10 through the intake port may be guided to the blowing fan 30 side through the air guide 17. The air guide 17 may form a portion of the flow path 20 therein. The air guide 17 may guide air inside the housing 10 and/or the flow path 20 to the blowing fan 30. Air passed through the inside of the air guide 17 may flow to the inside of a fan housing 18 and the blowing fan 30.

The housing 10 may include the fan housing 18. The blowing fan 30 may be disposed inside the fan housing 18. The fan housing 18 may form a portion of the flow path 20 therein. The fan housing 18 may guide a flow of air flowing inside the housing 10. The fan housing 18 may be in communication with the air guide 17. The fan housing 18 may be positioned above the air guide 17.

The blowing fan 30 may be disposed inside the fan housing 18. The fan housing 18 may form a portion of the flow path 20 therein. The fan housing 18 may guide the flow of air flowing inside the housing 10. The fan housing 18 may be in communication with the air guide 17.

The housing 10 may include a fixing member 19. The fixing member 19 may be provided such that a case 100 and the electrostatic precipitator 50 is fixed inside the housing 10. For example, the fixing member 19 may be coupled to the blowing panel 11 and the case 100, so that the case 100 may be fixed inside the housing 10. The fixing member 19 may be disposed between the case 100 and the air guide 18. A portion of the flow path 20 may be formed inside the fixing member 19.

The housing 10 may include the case 100. The case 100 may fix the electrostatic precipitator 50 inside the housing 10. The case 100 may be disposed on the outside of the electrostatic precipitator 50. The second intake port 14 may be formed on the case 100. The case 100 may be included in the electrostatic precipitator 50.

The flow path 20 may be formed inside the housing 10. The electrostatic precipitator 50 and the blowing fan 30 may be positioned on the flow path 20. The flow path 20 may include the first intake port 13a, the second intake port 14, and the exhaust port 13b. Air blown by the blowing fan 30 may flow into the flow path 20. For example, air passed through the first intake port 13a may flow to the second intake port 14, and air introduced into the flow path 20 through the second intake port 14 may flow to the exhaust port 13b after passing through the electrostatic precipitator 50. Air flowed into the exhaust port 13b may flow out of the flow path 20.

Air outside the housing 10 may flow into the housing 10 from four directions through the second intake port 14. For example, air outside the housing 10 may flow into the housing 10 from all directions through the second intake port 14. Also, for example, air inside the housing 10 may flow out of the housing 10 in four directions through the exhaust port 13b. For example, air inside the housing 10 may flow out of the housing 10 in all directions through the exhaust port 13b.

In an embodiment, the first intake port 13a and the second intake port 14 are provided as separate components, but the first intake port 13a and the second intake port 14 may be provided as a single component.

The air conditioner 1 may include the electrostatic precipitator 50. The electrostatic precipitator 50 may be disposed inside the housing 10. For example, the electrostatic precipitator 50 may be fixed inside the housing 10 by the case 100. The electrostatic precipitator 50 may filter air by capturing aerosols in the air.

The electrostatic precipitator 50 may be disposed between the second intake port 14 and the exhaust port 13b. For example, the electrostatic precipitator 50 may be positioned downstream of the second intake port 14 and upstream of the exhaust port 13b. The electrostatic precipitator 50 may filter air moved by the blowing fan 30 and introduced into the housing 10 through the first intake port 13a and the second intake port 14. The filtered air may be exhausted to the outside of the housing 10 through exhaust port 13b.

The electrostatic precipitator 50 may include a charging part 60 and a dust collecting part 80. The charging part 60 may charge aerosols in the air. The dust collecting part 80 may capture and remove aerosols charged by the charging part 60 from the air. The charging part 60 may be disposed further upstream than the dust collecting part 80.

The air conditioner 1 may include various filter devices (not shown) in addition to the electrostatic precipitator 50. For example, a fine dust collecting filter and/or a granular activated carbon filter in the form of a non-woven fabric formed of polypropylene resin or polyethylene resin may be selectively provided.

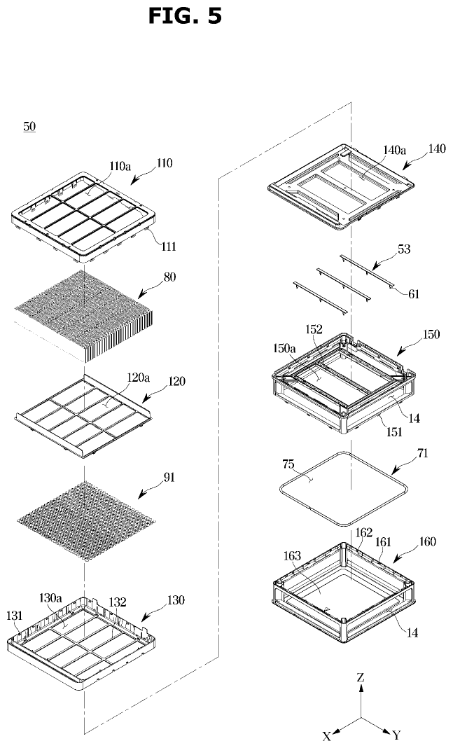

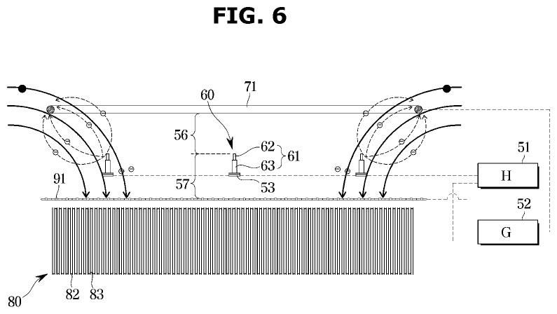

The charging part 60 may include the discharging electrode 61. The discharging electrode 61 may be disposed inside the housing 10. For example, the discharging electrode 61 may receive a high voltage from a power supply part 51 to emit electrons, and ions may be generated by corona discharge when the electrons collide with air molecules (see FIGS. 6 and 7). The discharging electrode 61 may receive a voltage and emit electrons, and the emitted electrons may generate negative or positive ions in a relationship with air molecules. For example, a voltage of 2000 V to 20000 V or less may be applied to the discharging electrode 61.

The discharging electrode 61 may include a plurality of the discharging electrodes 61. The plurality of discharging electrodes 61 may be arranged to be spaced apart from each other. The drawing illustrates the nine discharging electrodes 61 as an example, but the number of the discharging electrodes 61 is not limited thereto.

The charging part 60 may include a printed circuit board 53. The printed circuit board 53 may be electrically connected to the discharging electrode 61 to cause the discharging electrode 61 to emit electrons. The printed circuit board 53 may extend in one direction and be electrically connected to the plurality of discharging electrodes 61. The printed circuit board 53 may include a plurality of the printed circuit boards 53. The plurality of printed circuit boards 53 may be spaced apart from each other in different extension directions.

The charging part 60 may include an electric field induction electrode 71. The electric field induction electrode 71 may induce an electric field with the discharging electrode 61. The electric field induction electrode 71 may be disposed further upstream than the discharging electrode 61 with respect to the air flow direction. Additionally, the electric field induction electrode 71 may be the upstream electrode 71. The electric field induction electrode 71 may be disposed between the second intake port 14 and the discharging electrode 61. The electric field induction electrode 71 may be disposed closer to the second intake port 14 than to the exhaust port 13b.

At least a portion of the electric field induction electrode 71 may include a conductive material. At least a portion of the electric field induction electrode 71 may include a metal. At least a portion of the electric field induction electrode 71 may include a metal or a conductive material exhibiting similar electrical properties.

The electric field induction electrode 71 may be grounded with ground 52 (see FIGS. 6 and 7). For example, the electric field induction electrode 71 may maintain a voltage of about 0 V. The electric field induction electrode 71 may maintain a lower potential than the discharging electrode 61. Therefore, a constant potential difference may be formed between the electric field induction electrode 71 and the discharging electrode 61. An electric field may be formed between the electric field induction electrode 71 and the discharging electrode 61. A high density of ions may be generated between the discharging electrode 61 and the electric field induction electrode 71.

The electric field induction electrode 71 may include an electrode part 72. A portion or all of the electrode part 72 may include a conductive material. A portion or all of the electrode part 72 may include a metal. At least a portion of the electrode part 72 may include a metal or a conductive material exhibiting similar electrical properties.

The electric field induction electrode 71 may include a closed loop shape. The electric field induction electrode 71 may have a polygonal ring shape. The electrode part 72 may have a polygonal ring shape. The electrode part 72 may be formed in a closed loop shape to form an opening. Therefore, the opening may also have a polygonal shape. For example, the discharging electrode 61 may be disposed in an opening 75 formed by the electric field induction electrode 71.

The electrostatic precipitator 50 may include the dust collecting part 80. The dust collecting part 80 may include a first dust collecting electrode 82 and a second dust collecting electrode 83 (see FIG. 4). The first dust collecting electrode 82 and the second dust collecting electrode 83 may be alternately arranged in the front-rear direction and/or left-right direction. However, the present disclosure is not limited thereto. For example, the first dust collecting electrode 82 and the second dust collecting electrode 83 may be alternately arranged in the up-down direction.

The dust collecting part 80 may be electrically connected to the power supply part 51 (see FIGS. 6 and 7). A high voltage may be applied to the first dust collecting electrode 82 from the power supply part 51, and the second dust collecting electrode 83 may be grounded. A higher voltage may be applied to the first collecting electrode 82 than to the second collecting electrode 83, so that the first collecting electrode 82 may be formed as a plus (+) electrode and the second collecting electrode 83 may be formed as a minus (−) electrode. An electric field may be formed between the first collecting electrode 82 and the second collecting electrode 83, so that aerosols charged from the charging part 60 may be captured by the collecting electrodes 82 and 83.

Both surfaces of the dust collecting electrodes 82 and 83 may be coated with an insulator.

The blowing panel 11 may be disposed further upstream than the electrostatic precipitator 50 with respect to the air flow direction, so that the exposure of the electrostatic precipitator 50 to the outside of the housing 10 may be covered. The panel part 12 of the blowing panel 11 may cover the electrostatic precipitator 50. The panel part 12 of the electrostatic precipitator 50 may be disposed upstream with respect to the air flow direction.

The charging part 60 may further include a grounding electrode 91. The grounding electrode 91 may be disposed further downstream than the discharging electrode 61 with respect to the air flow direction. The grounding electrode 91 may be the downstream electrode 91. The grounding electrode 91 may be disposed between the discharging electrode 61 and the dust collecting part 80. The grounding electrode 91 may be disposed adjacent to the dust collecting part 80.

The grounding electrode 91 may be grounded with the ground 52 (see FIGS. 6 and 7). For example, the grounding electrode 91 may maintain a voltage of about 0 V. The grounding electrode 91 may maintain a lower potential than the discharging electrode 61. Therefore, a constant potential difference may be formed between the grounding electrode 91 and the discharging electrode 61. An electric field may be formed between the grounding electrode 91 and the discharging electrode 61. A high density of ions may be generated between the discharging electrode 61 and the grounding electrode 91.

The grounding electrode 91 may include a mesh shape. The grounding electrode 91 may include a plate shape. However, the grounding electrode 91 is not limited thereto and may have the same shape as the electric field induction electrode 71.

A portion or all of the grounding electrode 91 may include a conductive material. A portion or all of the grounding electrode 91 may include a metal. At least a portion of the grounding electrode 91 may include a metal or a conductive material exhibiting similar electrical properties.

The electrostatic precipitator 50 may include the case 100. The case 100 may be disposed inside formed by a plurality of blowing panels 11. Components of the electrostatic precipitator 50 may be accommodated in the case 100. The case 100 may form an accommodating space in which the components of the electrostatic precipitator 50 are accommodated. Accordingly, because the discharging electrode 61, the electric field induction electrode 71, the grounding electrode 91, the dust collecting part 80, and the like included in the electrostatic precipitator 50 are not exposed to the outside of the housing 10, the aesthetic sensibility of the air conditioner may be improved.

The case 100 may include dust collecting part cases 110, 120, and 130, and charging part cases 140, 150, and 160. The dust collecting part cases 110, 120, and 130 may be configured to accommodate the dust collecting electrodes 82 and 83, and communicating holes 110a, 120a, 130a, 140a, and 150a through which air passed through the charging part 60 passes may be formed on the dust collecting part cases 110, 120, and 130. The charging part cases 140, 150, and 160 may be configured to accommodate components for charging, such as the electric field induction electrode 71 and the discharging electrode 61, and the second intake port 14 may be formed through which air flows into the inside of the electrostatic precipitator 50. The drawing illustrates that the dust collecting part cases 110, 120, and 130 and the charging part cases 140, 150, and 160 are separate components, but the dust collecting part cases 110, 120, and 130 and the charging part cases 140, 150, and 160 may be formed integrally.

The dust collecting part cases 110, 120, and 130 may include a plurality of the dust collecting case parts 110, 120, and 130. The plurality of dust collecting case parts 110, 120, and 130 may include the first dust collecting case part 110, the second dust collecting case part 120, and the third dust collecting case part 130. However, the plurality of dust collecting case parts 110, 120, and 130 may be formed integrally to form a single case.

The first dust collecting case part 110 may be disposed above the dust collecting electrodes 82 and 83. The first dust collecting case part 110 may cover at least a portion of an upper portion and side portions of the dust collecting electrodes 82 and 83. The first dust collecting case part 110 may be disposed above the second dust collecting case part 120 and the third dust collecting case part 130. The first dust collecting case part 110 may be coupled with the third dust collecting case part 130. The first dust collecting case part 110 may include a coupling portion 111. The first dust collecting case part 110 and the third dust collecting case part 130 may be hook-coupled. The coupling portion 111 of the first dust collecting case part 110 may be hook-coupled with a coupling portion 131 of the third dust collecting case part 130. The dust collecting electrodes 82 and 83 may be accommodated in a space formed by the coupling of the first dust collecting case part 110 and the third dust collecting case part 130.

The first dust collecting case part 110 may include the first communicating hole 110a. The first communicating hole 110a may be formed on the first dust collecting case part 110. Air passed through the dust collecting electrodes 82 and 83 may flow to the blowing fan 30 side through the first communicating hole 110a. The first communicating hole 110a may be positioned and disposed upstream of the fan and downstream of the second intake port 14 on the flow path 20.

The second dust collecting case part 120 may be disposed below the dust collecting electrodes 82 and 83. The second dust collecting case part 120 may cover the front and a rear portion of the dust collecting electrodes 82 and 83. The second dust collecting case part 120 may support the dust collecting electrodes 82 and 83. The second dust collecting case part 120 may be disposed between the first dust collecting case part 110 and the third dust collecting case part 130. The second dust collecting case part 120 may be seated on the third dust collecting case part 130.

The second dust collecting case part 120 may include the second communicating hole 120a. The second communicating hole 120a may be formed on the second dust collecting case part 120. Air passed through the charging part 60 may pass the dust collecting electrodes 82 and 83 through the second communicating hole 120a. The second communicating hole 120a may be positioned and disposed upstream of the blowing fan 30 and downstream of the second intake port 14 on the flow path 20. Also, the second communicating hole 120a may be positioned and disposed upstream of the first communicating hole 110a on the flow path 20.

The third dust collecting case part 130 may be disposed below the dust collecting electrodes 82 and 83. The third dust collecting case part 130 may cover the front, rear, sides, and a lower portion of the dust collecting electrodes 82 and 83. The third dust collecting case part 130 may support the dust collecting electrodes 82 and 83. The third dust collecting case part 130 may be disposed below the first dust collecting case part 110 and the second dust collecting case part 120.

The third dust collecting case part 130 may be coupled with the first dust collecting case part 110. The third dust collecting case part 130 may include the coupling portion 131. The first dust collecting case part 110 and the third dust collecting case part 130 may be hook-coupled. The coupling portion 111 of the first dust collecting case part 110 may be hook-coupled with the coupling portion 131 of the third dust collecting case part 130. The dust collecting electrodes 82 and 83 may be accommodated in the space formed by the coupling of the first dust collecting case part 110 and the third dust collecting case part 130.

The third dust collecting case part 130 may include an electrode seating portion 132. The grounding electrode may be seated on the electrode seating portion 132.

The third dust collecting case part 130 may include the third communicating hole 130a. The third communicating hole 130a may be formed on the third dust collecting case part 130. Air passed through the charging part 60 may pass the dust collecting electrodes 82 and 83 through the third communicating hole 130a. The third communicating hole 130a may be positioned and disposed upstream of the blowing fan and downstream of the second intake port 14 on the flow path 20. Also, the third communicating hole 130a may be positioned and disposed upstream of the first communicating hole 110a and the second communicating hole 120a on the flow path 20.

The charging part cases 140, 150, and 160 may include a plurality of the charge cases parts 140, 150, and 160. The plurality of charge cases parts 140, 150, and 160 may include the first charge case part 140, the second charge case part 150, and the third charge case part 160. However, the plurality of charge cases parts 140, 150, and 160 may be formed integrally to form a single case.

The first charge case part 140 may be disposed above the discharging electrode 61, the printed circuit board 53, and the electric field induction electrode 71. The first charge case part 140 may cover the discharging electrode 61 and the printed circuit board 53.

The printed circuit board 53 may be bonded to the first charge case part 140. The first charge case part 140 may be disposed above the second charge case part 150 and the third charge case part 160.

The first charge case part 140 may include the fourth communicating hole 140a. The fourth communicating hole 140a may be formed on the first charge case part 140. Air passed through the intake ports 13a and 14 may flow to the dust collecting electrodes 82 and 83 through the fourth communicating hole 140a. The fourth communicating hole 140a may be positioned and disposed upstream of the blowing fan 30 and downstream of the second intake port 14 on the flow path 20.

The second charge case part 150 may be disposed below the first charge case part 140. The printed circuit board 53 may be seated on the second charge case part 150. Additionally, the discharging electrode 61 may be inserted into the second charge case part 150. The second charge case part 150 may support the printed circuit board 53 and/or the discharging electrode 61. The second charge case part 150 may be disposed between the first charge case part 140 and the third charge case part 160.

The second charge case part 150 may be coupled with the third charge case part 160. The second charge case part 150 may include a coupling portion 151. The second charge case part 150 and the third charge case part 160 may be hook-coupled. The coupling portion 151 of the second charge case part 150 may be hook-coupled with a coupling portion 161 of the third charge case part 160. The electric field induction electrode 71 may be accommodated in a space formed by the coupling of the second charge case part 150 and the third charge case part 160.

The second charge case part 150 may include the fifth communicating hole 150a. The fifth communicating hole 150a may be formed on the second charge case part 150. Air passed through the intake ports 13a and 14 may flow to the dust collecting electrodes 82 and 83 through the fifth communicating hole 150a. The fifth communicating hole 150a may be positioned and disposed upstream of the blowing fan 30 and downstream of the second intake port 14 on the flow path 20. Also, the fifth communicating hole 150a may be positioned and disposed upstream of the fourth communicating hole 140a on the flow path 20.

The second charge case part 150 may include a board seating portion 152. The board seating portions 152 may be provided to correspond to a number and shape of the printed circuit boards 53. The board seating portion 152 may extend in one direction. The printed circuit board 53 may be seated on the board seating portion 152, and the discharging electrode 61 may penetrate the board seating portion 152 and protrude to the third charge case part 160 side.

An electrode hole 152a may be formed on the board seating portion 152. The discharging electrode 61 may penetrate the electrode hole 152a. For example, the discharging electrode 61 penetrated through the electrode hole 152a may protrude downward.

The third charge case part 160 may be disposed below the second charge case part 150. The electric field induction electrode 71 may be seated on the third charge case part 160. The third dust collecting case part 130 may support the electric field induction electrode 71. The third charge case part 160 may be disposed below the first charge case part 140 and the second charge case part 150. The third charge case part 160 may be coupled with the second charge case part 150.

The third charge case part 160 may include an induction electrode seating portion 162. The induction electrode seating portion 162 may be provided to correspond to the shape of the electric field induction electrode 71. The induction electrode seating portion 162 may include a square shape. The electric field induction electrode 71 may be seated on the induction electrode seating portion 162 and may be disposed between the second charge case part 150 and the third charge case part 160.

The third charge case part 160 may include a bottom portion 163. The bottom portion 163 may prevent air introduced into the inside of the charging part cases 140, 150, and 160 through the second intake port 14 from escaping downward.

An intake port may be formed on the second charge case part 150 and the third charge case part 160. For example, the second intake port 14 may be formed on sides of the second charge case part 150 and the third charge case part 160. The second intake port 14 may be formed on four sides of the second charge case part 150 and on four sides of the third charge case part 160. Accordingly, air may flow into the insides of the charging part cases 140, 150, and 160 from four directions.

FIG. 6 is a schematic view of the air conditioner according to an embodiment. FIG. 7 is a schematic view of the air conditioner according to an embodiment.

FIG. 6 illustrates that ions are generated between the discharging electrode 61 and the electric field induction electrode 71, and FIG. 7 illustrates that ions are generated between the discharging electrode 61 and the grounding electrode 91.

Referring to FIGS. 6 and 7, the blowing fan 30 may cause air to flow from upstream to downstream.

The discharging electrode 61 may be disposed to generate ions toward the second intake port 14. The discharging electrode 61 may emit electrons toward the upstream of the air flow path 20. Ions generated by collisions between electrons emitted from the discharging electrode 61 and air molecules may move in a direction opposite to the air flow direction.

The discharging electrode 61 may include a brush 62. The brush 62 may include a plurality of conductive fibers. The conductive fiber may be made of, for example, carbon fiber. For example, an electrical conductivity of the discharging electrode 61 may be formed of a material having a conductivity of 10% IACS or more and 110% IACS or less.

The discharging electrode 61 may have an aspect ratio of 2:1 or more and 100:1 or less. For example, a Z-direction length/a Y-direction length of the discharging electrode 61 may be 2 or more and 100 or less.

One end of the brush 62 may be disposed toward the upstream of the air flow path 20. The other end of the brush 62 may be caulked to a caulking portion 63.

However, the present disclosure is not limited thereto, and the discharging electrode 61 may be made of other materials or have other shapes. The discharging electrode 61 may be implemented in other structures as long as it may generate ions through corona discharge with air molecules when a voltage is applied.

When a voltage is applied to the discharging electrode 61, corona discharge may occur at the discharging electrode 61. The discharging electrode 61 may generate electrons to generate ions in a relationship with air molecules.

For example, when the minus (−) electrode is applied to the discharging electrode 61 so that the discharging electrode 61 generates negative ions, the negative ions may charge aerosols 40 to the minus (−) electrode. When the plus (+) electrode is applied to the discharging electrode 61 so that the discharging electrode 61 generates positive ions, the positive ions may charge the aerosols 40 to the plus (+) electrode. The drawing illustrates, as an example, that the discharging electrode 61 generates negative ions, but the present disclosure is not limited thereto. For example, the discharging electrode 61 may also generate positive ions.

Because the electric field induction electrode 71 maintains a potential difference with the discharging electrode 61, the corona discharge continues to occur at the discharging electrode 61, so that ions may continue to be generated.

By an action between the electric field induction electrode 71 and the discharging electrode 61, electric field charging may occur inside the housing 10. Ions generated from the discharging electrode 61 may charge the aerosols 40 in the air between the discharging electrode 61 and the electric field induction electrode 71.

For example, electric field charging may occur in a first space 56. The first space 56 may be a space inside the housing 10. The first space 56 may be a space between the discharging electrode 61 and the electric field induction electrode 71. The first space 56 may be a space positioned further upstream than the discharging electrode 61. The first space 56 may be a space positioned further downstream than the electric field induction electrode 71.

The ions generated by the discharging electrode 61 may charge the aerosols 40 in the air in the first space 56. The aerosols 40 generated in the first space 56 may be captured by the dust collecting part 80.

Electric field charging may occur by an action between the grounding electrode 91 and the discharging electrode 61. The ions generated by the discharging electrode 61 may charge the aerosols 40 in the air between the discharging electrode 61 and the grounding electrode 91.

For example, electric field charging may occur in a second space 57. The second space 57 may be a space between the discharging electrode 61 and the grounding electrode 91. The second space 57 may be a space positioned further downstream than the discharging electrode 61. The second space 57 may be a space positioned further upstream than the grounding electrode 91.

The ions generated by the discharging electrode 61 may charge the aerosols 40 in the air in the second space 57. The aerosols 40 generated in the second space 57 may be captured by the dust collecting part 80.

The grounding electrode 91 may strengthen an electric field downstream of the discharging electrode 61, thereby increasing efficiency of charging the aerosols 40 in the charging part 60.

Additionally, ions generated through the discharging electrode 61 may be removed while passing through the grounding electrode 91, thereby preventing ion accumulation at the dust collecting electrodes 82 and 83. Therefore, the decrease in electric field strength between the discharging electrode 61 and the electric field induction electrode 71 may be minimized by the accumulation of ions at the dust collecting electrodes 82 and 83.

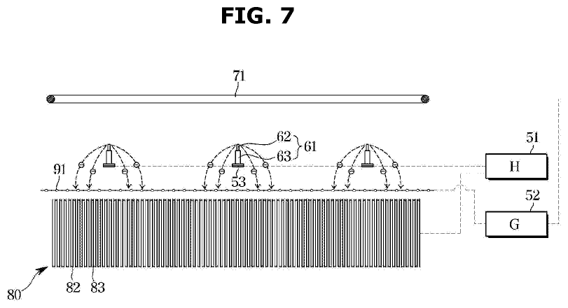

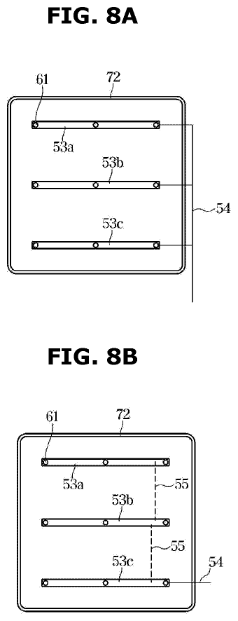

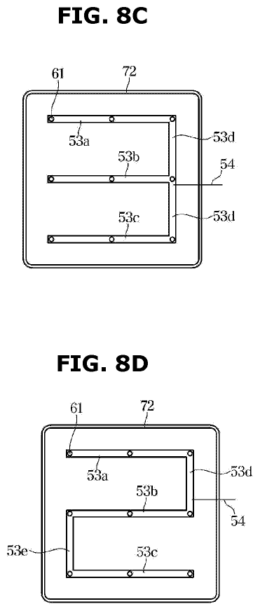

Each of FIGS. 8A, 8B, 8C and 8D is a schematic view of the air conditioner according to an embodiment. Each of FIGS. 8A, 8B, 8C and 8D is a schematic view of the charging part 60.

Referring to FIGS. 8A, 8B, 8C and 8D, the plurality of discharging electrodes 61 may be electrically connected to each of the plurality of printed circuit boards 53. The plurality of printed circuit boards 53 may include a first printed circuit board 53a, a second printed circuit board 53b, and a third printed circuit board 53c.

Each of the plurality of printed circuit boards 53 may extend in a first direction. The plurality of printed circuit boards 53 may be spaced apart from each other in a second direction different from the first direction. For example, the first printed circuit board 53a, the second printed circuit board 53b, and the third printed circuit board 53c may be spaced apart from each other in the second direction.

The plurality of discharging electrodes 61 may be electrically connected to each of the first printed circuit board 53a, the second printed circuit board 53b, and the third printed circuit board 53c. For example, the three discharging electrodes 61 may be electrically connected to each of the first printed circuit board 53a, the second printed circuit board 53b, and the third printed circuit board 53c.

Referring to FIG. 8A, the plurality of printed circuit boards 53 may each be connected to the power supply part 51 via an external wire 54 to receive power. For example, the first printed circuit board 53a, the second printed circuit board 53b, and the third printed circuit board 53c may be connected to the power supply part 51 via the external wires 54, respectively, to receive power. The external wire 54 may be a wire separately connecting each of the plurality of printed circuit boards 53.

Referring to FIG. 8B, the plurality of printed circuit boards 53 may each be connected to the power supply part 51 through an internal wire 55 to receive power. For example, the first printed circuit board 53a, the second printed circuit board 53b, and the third printed circuit board 53c may be directly connected to each other via the internal wires 55, and at least one of the first printed circuit board 53a, the second printed circuit board 53b, and/or the third printed circuit board 53c may be connected to the power supply part 51 to receive power. The internal wires 55 may be a wire directly connecting the plurality of printed circuit boards 53 therebetween. The first printed circuit board 53a, the second printed circuit board 53b, and the third printed circuit board 53c may be the first board part 53a, the second board part 53b, and the third board part 53c, respectively.

Referring to FIG. 8C, the plurality of printed circuit boards 53 may include a fourth printed circuit board 53d. The fourth printed circuit board 53d may extend in the second direction to connect at least one of the first printed circuit board 53a, the second printed circuit board 53b, and the third printed circuit board 53c. The fourth printed circuit board 53d may electrically connect the first printed circuit board 53a, the second printed circuit board 53b, and/or the third printed circuit board 53c. The fourth printed circuit board 53d may be connected to one end of the first printed circuit board 53a, the second printed circuit board 53b, and the third printed circuit board 53c in the first direction. The fourth printed circuit board 53d may be the fourth board part 53d.

Referring to FIG. 8D, the plurality of printed circuit boards 53 may include the fourth printed circuit board 53d and a fifth printed circuit board 53e. The fourth printed circuit board 53d may be extended in the second direction to connect the first printed circuit board 53a and the second printed circuit board 53b. The fourth printed circuit board 53d may electrically connect the first printed circuit board 53a and the second printed circuit board 53b. The fourth printed circuit board 53d may be connected to one end of the first printed circuit board 53a and the second printed circuit board 53b in the first direction. The fifth printed circuit board 53e may extend in the second direction to connect the second printed circuit board 53b and the third printed circuit board 53c. The fifth printed circuit board 53e may electrically connect the second printed circuit board 53b and the third printed circuit board 53c. The fifth printed circuit board 53e may be connected to the other end of the second printed circuit board 53b and the third printed circuit board 53c in the first direction. The fifth printed circuit board 53e may be the fifth board part 53e.

The electric field induction electrode 71 may be configured to surround the plurality of discharging electrodes 61.

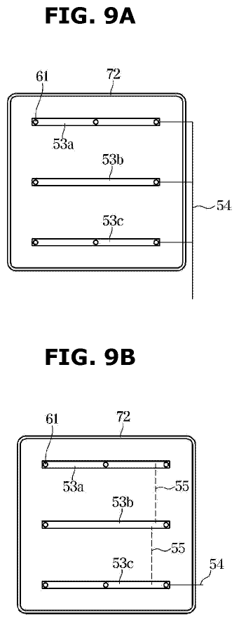

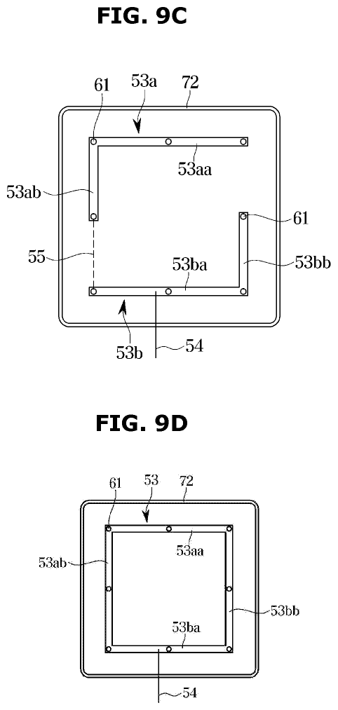

Each of FIGS. 9A, 9B, 9C and 9D is a schematic view of the air conditioner according to an embodiment. Each of FIGS. 9A, 9B, 9C and 9D is a schematic view of the charging part 60.

Referring to FIGS. 9A, 9B, 9C and 9D, the plurality of discharging electrodes 61 may be provided in eight discharging electrodes. For example, when a flow rate of air flowing in the flow path 20 and/or a central portion of the housing 10 is not large, the discharging electrode 61 disposed in the central portion may be omitted. Therefore, a manufacturing cost of electrostatic precipitator 50 may be reduced.

Referring to FIGS. 9A and 9B, the plurality of discharging electrodes 61 may be electrically connected to each of the first printed circuit board 53a, the second printed circuit board 53b, and the third printed circuit board 53c. For example, the three discharging electrodes 61 may be electrically connected to each of the first printed circuit board 53a and the third printed circuit board 53c, and the two discharging electrodes 61 may be electrically connected to the second printed circuit board 53b.

Referring to FIG. 9C, the first printed circuit board 53a may include a first board part 53aa extending in the first direction and a second board part 53ab extending in the second direction. For example, the second board part 53ab may extend from one end of the first board part 53aa.

The second printed circuit board 53b may include a first board part 53ba extending in the first direction and a second board part 53bb extending in a third direction. For example, the second board part 53bb may extend from one end of the first board part 53ba. The third direction may be a direction opposite to the second direction. The first direction may be a direction perpendicular to the second direction, and the first direction may be a direction perpendicular to the third direction.

For example, the four discharging electrodes 61 may be electrically connected to each of the first printed circuit board 53a and the second printed circuit board 53b.

Referring to FIG. 9D, the printed circuit board 53 may include a first board part 53aa, a second board part 53ab, a third board part 53ba, and a fourth board part 53bb. The first board part 53aa, the second board part 53ab, the third board part 53ba, and the fourth board part 53bb may be connected to each other to form a substantially square shape. The eight discharging electrodes 61 may be electrically connected to the printed circuit board 53.

The first board part 53aa may extend in the first direction. The second board part 53ab may extend in the second direction from one end of the first board part 53aa along the first direction. The third board part 53ba may be spaced apart from the first board part 53aa in the second direction, and may extend in the first direction from one end of the second board part 53ab along the second direction. The fourth board part 53bb may be spaced apart from the second board part 53ab in the first direction, and may extend in the second direction and/or the third direction from one ends of the first board part 53aa and the third board part 53ba along the first direction. The fourth board part 53bb may connect the first board part 53aa and the third board part 53ba.

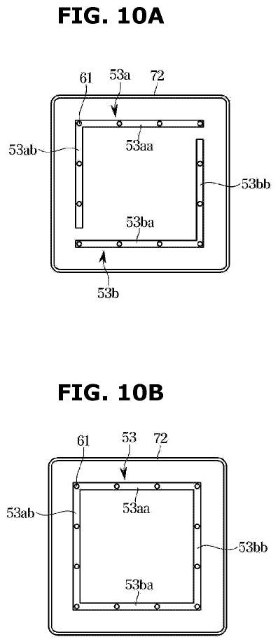

Each of FIGS. 10A and 10B is a schematic view of the air conditioner according to an embodiment. Each of FIGS. 10A and 10B is a schematic view of the charging part 60.

Referring to FIGS. 10A and 10B, the twelve discharging electrodes 61 may be electrically connected to the printed circuit board 53. For example, referring to FIG. 10A, the six discharging electrodes 61 may be electrically connected to each of the first printed circuit board 53a and the second printed circuit board 53b. However, the present disclosure is not limited thereto, and more than the twelve discharging electrodes 61 may be electrically connected to the printed circuit board 53, and more than the six discharging electrodes 61 may be electrically connected to each of the first printed circuit board 53a and the second printed circuit board 53b.

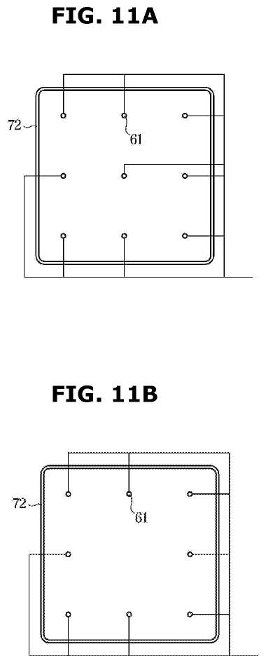

Each of FIGS. 11A and 11B is a schematic view of the air conditioner according to an embodiment. Each of FIGS. 11A and 11B is a schematic view of the charging part 60.

Referring to FIGS. 11A and 11B, the discharging electrode 61 may be connected directly to a wire without being connected to the printed circuit board 53. For example, when there are the nine discharging electrodes 61, nine wires may be provided in the air conditioner 1.

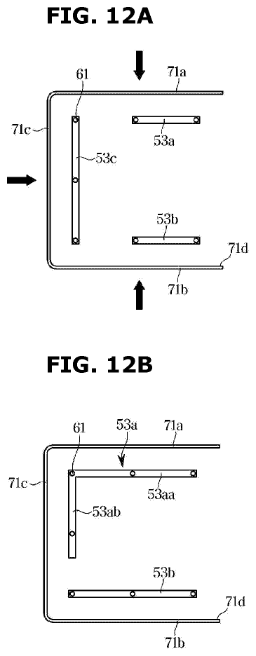

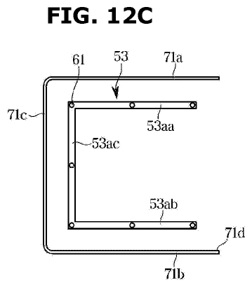

Each of FIGS. 12A, 12B and 12C is a schematic view of the air conditioner according to an embodiment. Each of FIGS. 12A, 12B and 12C is a schematic view of the charging part 60.

Referring to FIGS. 12A, 12B and 12C, the electric field induction electrode 71 may include a first side 71a, a second side 71b spaced apart from the first side 71a, a third side 71c connecting the first side 71a and the second side 71b between the first side 71a and the second side 71b, and a fourth side 71d between the first side 71a and the second side 71b. The fourth side 71d may be open. For example, because there is no air flowing in when one side of the intake ports 13a and 14 provided in four directions is closed, the electric field induction electrode 71 may not be provided by corresponding to the closed side.

The plurality of printed circuit boards 53 may include the first printed circuit board 53a, the second printed circuit board 53b, and the third printed circuit board 53c.

Referring to FIG. 12A, the first printed circuit board 53a may be adjacent to the first side 71a of the electric field induction electrode 71 more than the second printed circuit board 53b and the third printed circuit board 53c. The first printed circuit board 53a may extend in the first direction.

The second printed circuit board 53b may be spaced apart from the first printed circuit board 53a. The second printed circuit board 53b may be adjacent to the second side 71b of the electric field induction electrode 71 more than the first printed circuit board 53a and the third printed circuit board 53c. The second printed circuit board 53b may extend in the first direction.

The third printed circuit board 53c may be adjacent to the third side 71c of the electric field induction electrode 71 more than the first printed circuit board 53a and the second printed circuit board 53b. The third printed circuit board 53c may extend in the second direction different from the first direction.

Referring to FIG. 12B, the first printed circuit board 53a may include a first board part 53aa and a second board part 53ab. The first board part 53aa may extend in the first direction, and the second board part 53ab may extend in the second direction from one end of the first board part 53aa. The first board part 53aa may be adjacent to the first side 71a of the electric field induction electrode 71, and the second board part 53ab may be adjacent to the third side 71c of the electric field induction electrode 71.

The second printed circuit board 53b may be spaced apart from the first printed circuit board 53a. The second printed circuit board 53b may be adjacent to the second side 71b of the electric field induction electrode 71 more than the first printed circuit board 53a. The second printed circuit board 53b may extend in the first direction.

Referring to FIG. 12C, the printed circuit board 53 may include a first board part 53aa, a second board part 53ab, and a third board part 53ac. The first board part 53aa may extend in the first direction. The second board part 53ab may be spaced apart from the first board part 53aa in the second direction and may be connected to the third board part 53ac. The third board part 53ac may extend in the second direction from one end of the first board part 53aa and one end of the second board part 53ab. The third board part may be disposed between the first board part 53aa and the second board part 53ab.

The first board part 53aa may be adjacent to the first side 71a of the electric field induction electrode 71, the second board part 53ab may be adjacent to the second side 71b of the electric field induction electrode 71, and the third board part 53ac may be adjacent to the third side 71c of the electric field induction electrode 71.

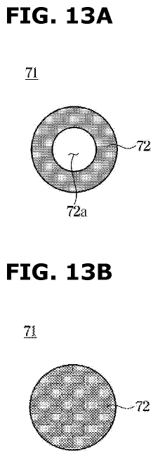

Each of FIGS. 13A and 13B is a schematic view of the air conditioner according to an embodiment. Each of FIGS. 13A and 13B is a cross-sectional view of the electric field induction electrode 71.

Referring to FIGS. 13A and 13B, the electric field induction electrode 71 may include a rod shape. For example, the electric field induction electrode 71 may have a diameter between 2 and 7 mm.

Referring to FIGS. 13A and 13B, the electric field induction electrode 71 may include the electrode part 72 and a hollow portion 72a. The hollow portion 72a may be formed within the electrode part 72. The electric field induction electrode 71 is not formed entirely as the electrode part 72, but may be formed as the electrode part 72 and the hollow part 72a, thereby reducing a material cost.

On the other hand, referring to FIG. 13B, the electric field induction electrode 71 may not include the hollow portion 72a. Therefore, the electric field induction electrode 71 may smoothly induce ion generation in relation to the discharging electrode 61.

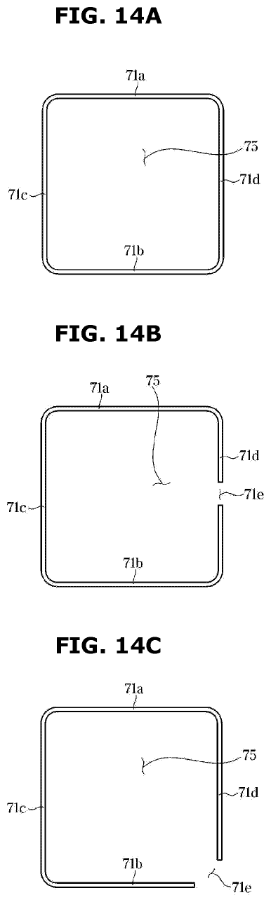

Each of FIGS. 14A, 14B and 14C is a schematic view of the air conditioner according to an embodiment. Each of FIGS. 14A, 14B and 14C is a schematic view of the electric field induction electrode 71.

Referring to FIGS. 14A, 14B and 14C, the electric field induction electrode 71 may include a substantially square shape. The electric field induction electrode 71 may include a first side 71a, a second side 71b opposite the first side 71a, a third side 71c connected to one end of each of the first side 71a and the second side 71b to connect the first side 71a and the second side 71b, and a fourth side 71d connected to the other end of each of the first side 71a and the second side 71b to connect the first side 71a and the second side 71b. A space formed by the first side 71a, the second side 71b, the third side 71c and the fourth side 71d may have an opening 75.

Referring to FIG. 14A, the electric field induction electrode 71 may include a closed loop shape in which the first side 71a, the second side 71b, the third side 71c, and the fourth side 71d are all connected.

On the other hand, referring to FIG. 14B, the electric field induction electrode 71 may have an opening 71e formed at a portion of the fourth side 71d. The drawing illustrates an opening formed on the fourth side 71d, but an opening may also be formed on the first side 71a, the second side 71b, or the third side 71c.

Referring to FIG. 14C, an opening 71e may be formed at a portion connecting the second side 71b and the third side 71c of the electric field induction electrode 71.

Accordingly, the cost of the material forming the electric field induction electrode 71 may be reduced. For example, a rod made of metal may be formed by being bent, and thus when the opening 71e is formed, an amount of metal rod required is reduced, so that the material cost may be reduced.

The electric field induction electrode 71 may include the first side 71a, the second side 71b spaced apart from the first side 71a, the third side 71c connecting the first side 71a and the second side 71b between the first side 71a and the second side 71b, and the fourth side 71d between the first side 71a and the second side 71b. The fourth side 71d may be open. For example, because there is no air flowing in when one side of the intake ports 13a and 14 provided in four directions is closed, the electric field induction electrode 71 may not be provided by corresponding to the closed side.

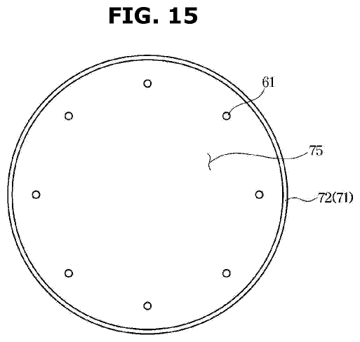

FIG. 15 is a schematic view of the air conditioner according to an embodiment. FIG. 15 is a schematic view of the charging part 60.

Referring to FIG. 15, the electric field induction electrode 71 may include an annular shape. For example, the electric field induction electrode 71 may be formed in an annular shape. When viewed from an upper end of the electrostatic precipitator 50, the plurality of discharging electrodes 61 may be arranged in an opening formed by the electric field induction electrode 71. The plurality of discharging electrodes 61 may be formed by corresponding to the shape of the electric field induction electrode 71. Accordingly, the plurality of discharging electrodes 61 may be arranged in an annular shape.

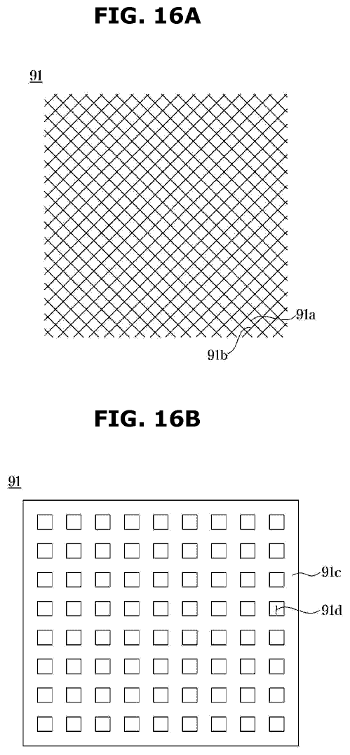

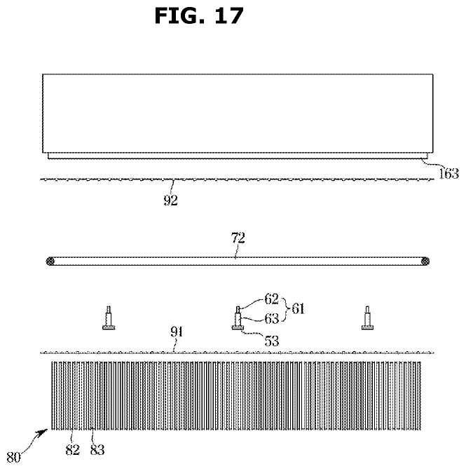

Each of FIGS. 16A and 16B is a schematic view of the air conditioner according to an embodiment. Each of FIGS. 16A and 16B is a schematic view of the grounding electrode 91.

Referring to FIGS. 16A and 16B, the grounding electrode 91 may include various shapes.

For example, referring to FIG. 16A, the grounding electrode 91 may include a mesh shape. For example, the grounding electrode 91 may include a first extension part 91a and a second extension part 91b. The first extension part 91a and the second extension part 91b may extend in directions intersecting each other. For example, the first extension part 91a may extend in the first direction, and the second extension part 91b may extend in the second direction intersecting the first direction.

Because the first extension part 91a may include a plurality of the first extension parts 91a and the second extension part 91b may include a plurality of the second extension parts 91b, the plurality of first extension parts 91a and the plurality of second extension parts 91b may form a mesh shape by intersecting each other.

Additionally, for example, referring to FIG. 16B, the grounding electrode 91 may include a plate part 91c and a hole 91d. The hole 91d may be formed by perforating plate part 91c. The hole 91d may be provided in plurality. Air may pass through the plurality of holes 91d, and ions in the air may be attached to the plate part 91c.

The plurality of holes 91d may include various shapes. For example, the plurality of holes 91d may include polygons and/or circles. For example, the plurality of holes 91d may include triangles, squares and/or pentagons.

FIG. 17 is a schematic view of the air conditioner according to an embodiment.

Referring to FIG. 17, the electrostatic precipitator 50 may include a first grounding electrode 91 and a second grounding electrode 92.

The first grounding electrode 91 and the second grounding electrode 92 may be grounded with the ground 52. For example, the first grounding electrode 91 and the second grounding electrode 92 may maintain a voltage of substantially 0 V. The first grounding electrode 91 and the second grounding electrode 92 may maintain a lower potential than the discharging electrode 61.

The first grounding electrode 91 and the second grounding electrode 92 may include a mesh shape. Additionally, the first grounding electrode 91 and the second grounding electrode 92 may include a plate shape. However, the shapes of the first grounding electrode 91 and the second grounding electrode 92 are not limited to the above examples.

Portions or all of the first grounding electrode 91 and the second grounding electrode 92 may include a conductive material. Portions or all of the first grounding electrode 91 and the second grounding electrode 92 may include a metal. At least portions of the grounding electrode 91 and the second grounding electrode 92 may include a metal or a conductive material exhibiting similar electrical properties.

The first grounding electrode 91 may be disposed between the discharging electrode 61 and the dust collecting electrodes 82 and 83. For example, the first grounding electrode 91 may be disposed below the dust collecting electrodes 82 and 83 and above the discharging electrode 61. The first grounding electrode 91 may be disposed upstream of the dust collection electrodes 82 and 83 and downstream of the discharging electrode 61.

The second grounding electrode 92 may be disposed between the electric field induction electrode 71 and the bottom portion 163 of the third charge case part 160. For example, the second grounding electrode 92 may be disposed below the electric field induction electrode 71 and above the bottom portion 163 of the third charge case part 160. The second grounding electrode 92 may be disposed upstream of the electric field induction electrode 71.

The second grounding electrode 92 may strengthen an electric field upstream of the discharging electrode 61, thereby increasing efficiency of charging the aerosols 40 in the charging part 60.

Additionally, ions generated through the discharging electrode 61 and moved to the third charge case part 160 side may be removed by the second grounding electrode 92, thereby preventing ion accumulation at the third charge case part 160 side. Therefore, the decrease in electric field strength between the discharging electrode 61 and the electric field induction electrode 71 may be minimized by the accumulation of ions at the second grounding electrode 92.

Additionally, when there is the second grounding electrode 92, the electric field induction electrode 71 may be omitted.

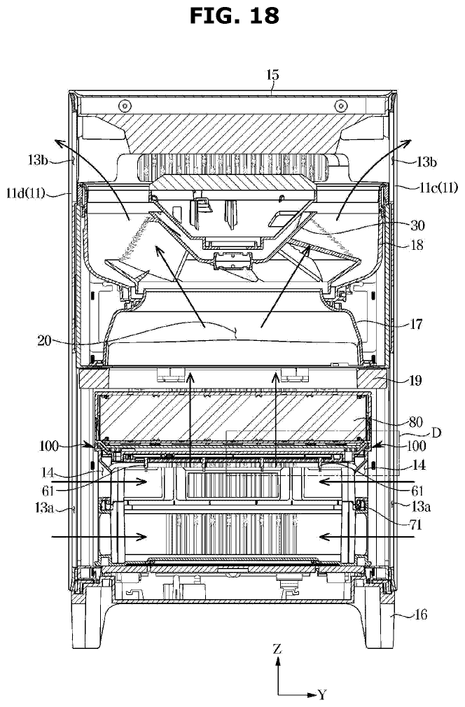

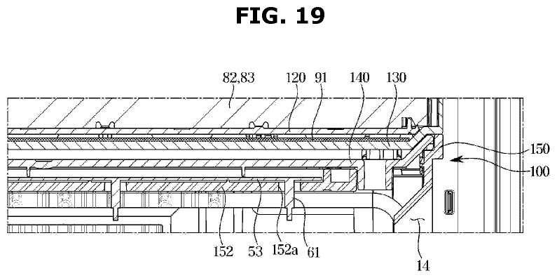

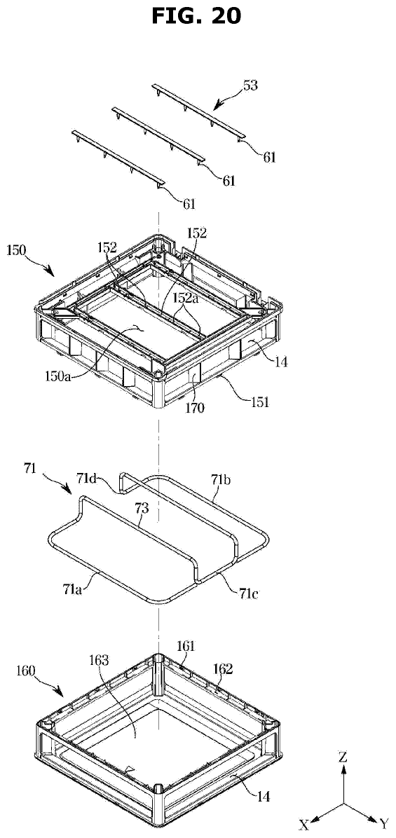

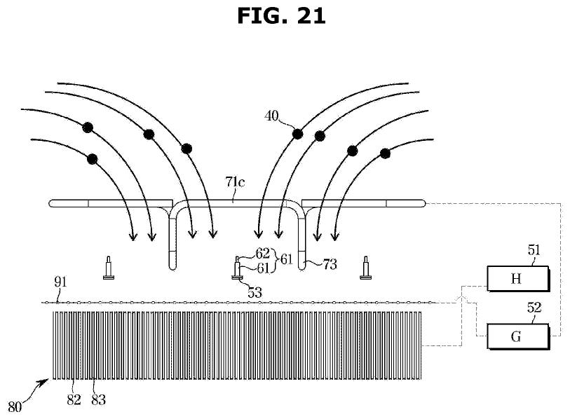

FIG. 18 is a cross-sectional view of the air conditioner according to an embodiment. FIG. 19 is an enlarged view of the air conditioner according to an embodiment. FIG. 20 is an exploded perspective view of the air conditioner according to an embodiment.

FIG. 18 is a cross-sectional view cut along line B-B′ of the air conditioner shown in FIG. 1. FIG. 19 is an enlarged view of area D shown in FIG. 18. FIG. 20 is an exploded perspective view of components of the charging part.

Referring to FIGS. 18 to 20, the electrostatic precipitator 50 may include the discharging electrode 61 and the electric field induction electrode 71.

The discharging electrode 61 may be provided in plurality. For example, the four discharging electrodes 61 may be electrically connected to each of the plurality of printed circuit boards 53. The four discharging electrodes 61 may be arranged along a Y direction. The plurality of printed circuit boards 53 may be arranged along an X direction. As the discharging electrode 61 is provided in plurality, charging efficiency of the aerosol 40 in the charging part 60 may be improved.

The electric field induction electrode 71 may include the flat portions 71a, 71b, and 71c. The flat portions 71a, 71b, and 71c may include the first side 71a, the second side 71b spaced apart from the first side 71a, the third side 71c connecting the first side 71a and the second side 71b between the first side 71a and the second side 71b, and the fourth side 71d between the first side 71a and the second side 71b. For example, a portion of the fourth side 71d may be open. The flat portions 71a, 71b, and 71c may be referred to as the horizontal portions 71a, 71b, and 71c. The horizontal portions 71a, 71b, and 71c may be disposed below the discharging electrode 61.

The electric field induction electrode 71 may further include a protrusion portion 73. The protrusion portion 73 may protrude from the flat portions 71a, 71b, and 71c. For example, the protrusion portion 73 may extend upward by being bent from the flat portions 71a, 71b, and 71c. The protrusion portion 73 may protrude from the horizontal portions 71a, 71b, and 71c toward the discharging electrode 61.

The protrusion portion 73 may include a plurality of the protrusion portions 73. The plurality of protrusion portions 73 may be spaced apart from each other. For example, the plurality of protrusion portions 73 may be spaced apart in the X direction. The plurality of protrusion portions 73 may be provided with an open portion of the fourth side 71d.

The plurality of protrusion portions 73 may be disposed between the first side 71a and the second side 71b of the flat portions 71a, 71b, and 71c. For example, the first side 71a, the plurality of protrusion portions 73, and the second side 71b may be arranged along the X direction.

As the plurality of protrusion portions 73 is provided in the electric field induction electrode 71, the charging efficiency of the aerosols 40 in the charging part 60 may be improved.

The printed circuit board 53 may be seated on the second charge case part 150. Additionally, the discharging electrode 61 may be inserted into the second charge case part 150. The second charge case part 150 may support the printed circuit board 53 and/or the discharging electrode 61.

The second charge case part 150 may include a board seating portion 152. The printed circuit board 53 may be seated on the board seating portion 152, and the discharging electrode 61 may protrude to the third charge case part 160 side by penetrating the board seating portion 152.

The electrode hole 152a may be formed on the board seating portion 152. The discharging electrode 61 may penetrate the electrode hole 152a. For example, the discharging electrode 61 penetrated through the electrode hole 152a may protrude downward.

The second charge case part 150 may be coupled with the third charge case part 160. The electric field induction electrode 71 may be accommodated in the space formed by coupling the second charge case part 150 and the third charge case part 160.

The third charge case part 160 may be disposed below the second charge case part 150. The electric field induction electrode 71 may be seated on the third charge case part 160. The third dust collection case part 130 may support the electric field induction electrode 71. The third charge case part 160 may be disposed below the first charge case part 140 and the second charge case part 150. The third charge case part 160 may be coupled with the second charge case part 150.

The third charge case part 160 may include the induction electrode seating portion 162. The induction electrode seating portion 162 may be provided to correspond to the shape of the electric field induction electrode 71. The induction electrode seating portion 162 may include a square shape. The electric field induction electrode 71 may be seated on the induction electrode seating portion 162, and may be disposed between the second charge case part 150 and the third charge case part 160.

The third charge case part 160 may include the bottom portion 163. The bottom portion 163 may prevent air introduced into the inside of the charging part cases 140, 150, and 160 through the second intake port 14 from escaping downward.

The electrostatic precipitator 50 may include an air guide 170. The air guide 170 may guide air introduced from the outside of the housing 10 into the inside of the housing 10. The air guide 170 may guide air introduced into the inside of the charging part cases 140, 150, and 160 to be evenly dispersed. For example, the air guide 170 may increase the charging efficiency by guiding air flowed to the inside of the charging part cases 140, 150, and 160 to flow toward the discharging electrode 61 and the electric field induction electrode 71. As the charging efficiency increases, the dust collection efficiency of the dust collecting part 80 may also increase.

The air guide 170 may be formed in the charging part cases 140, 150, and 160. For example, the air guide 170 may be formed in the second charge case part 150. The air guide 170 may include a plurality of the air guides 170.

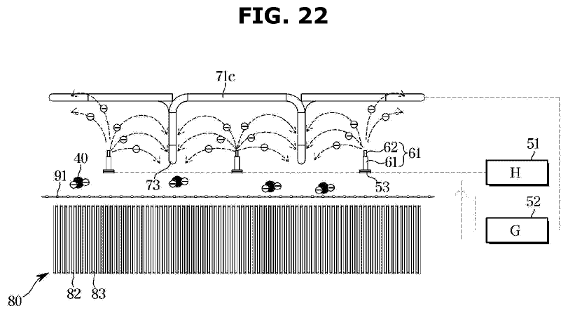

FIG. 21 is a schematic view of the air conditioner according to an embodiment. FIG. 22 is a schematic view of the air conditioner according to an embodiment.

FIG. 21 illustrates that ions are generated between the discharging electrode 61 and the electric field induction electrode 71, and FIG. 22 illustrates that ions are generated between the discharging electrode 61 and the grounding electrode 91.

Referring to FIGS. 21 and 22, the blowing fan 30 may be configured to flow air from upstream to downstream.

The discharging electrode 61 may be disposed to generate ions toward the second intake port 14. The discharging electrode 61 may emit electrons toward the upstream of the air flow path 20. Ions generated by collisions between electrons emitted from the discharging electrode 61 and air molecules may move in a direction opposite to the air flow direction.

When a voltage is applied to the discharging electrode 61, corona discharge may occur at the discharging electrode 61. The discharging electrode 61 may generate electrons to generate ions in the relationship with air molecules.

For example, when the minus (−) electrode is applied to the discharging electrode 61 so that the discharging electrode 61 generates negative ions, the negative ions may charge the aerosols 40 to the minus (−) electrode. When the plus (+) electrode is applied to the discharging electrode 61 so that the discharging electrode 61 generates positive ions, the positive ions may charge the aerosols 40 to the plus (+) electrode. The drawing illustrates, as an example, that the discharging electrode 61 generates negative ions, but the present disclosure is not limited thereto. For example, the discharging electrode 61 may also generate positive ions.

Because the electric field induction electrode 71 maintains the potential difference with the discharging electrode 61, the corona discharge continues to occur at the discharging electrode 61, so that ions may continue to be generated.

By the action between the electric field induction electrode 71 and the discharging electrode 61, electric field charging may occur inside the housing 10. Ions generated from the discharging electrode 61 may charge the aerosols 40 in the air between the discharging electrode 61 and the electric field induction electrode 71.

Additionally, electric field charging may occur by the action between the grounding electrode 91 and the discharging electrode 61. The ions generated by the discharging electrode 61 may charge the aerosols 40 in the air between the discharging electrode 61 and the grounding electrode 91.

The ions generated by the discharging electrode 61 may charge the aerosols 40 in the air.

Due to the plurality of discharging electrodes 61 and the plurality of protrusion portions 73 of the electric field induction electrode 71, the efficiency of charging the aerosol 40 in the charging part 60 may be increased. For example, air introduced into the housing 10 may be more efficiently charged due to the plurality of discharging electrodes 61 and the plurality of protrusion portions 73 in the central portion of the housing 10.

The charged aerosol 40 may be captured by the dust collecting part 80. Because an electric field is formed between the first dust collecting electrode 82 and the second dust collecting electrode 83, the aerosols 40 charged from the charging part 60 may be captured in the dust collecting electrodes 82 and 83.

An air conditioner according to an embodiment may include a blowing fan 30 configured to form an air flow, a housing 10 configured to accommodate the blowing fan and including a first surface 11a, a second surface 11b opposite the first surface, a third surface 11c between the first surface and the second surface, and a fourth surface 11d opposite the third surface between the first surface and the second surface, the housing having intake ports 13a and 14 formed on the first surface, the second surface, the third surface, and the fourth surface, and an electrostatic precipitator 50 accommodated in the housing, wherein the electrostatic precipitator 50 may include dust collecting electrodes 82 and 83 configured to capture aerosols from air introduced into the housing by the blowing fan, a discharging electrode 61 configured to generate ions toward the intake ports and positioned upstream of the dust collecting electrodes, an electric field induction electrode 71 grounded to form an electric field with the discharging electrode and positioned upstream of the discharging electrode, and a grounding electrode 91 positioned downstream of the discharging electrode and upstream of the dust collecting electrodes so that the ions are attached thereto.

The grounding electrode may be a first grounding electrode 91, the discharging electrode may be disposed above the electric field induction electrode and below the first grounding electrode, and the electrostatic precipitator may further include a second grounding electrode 92 disposed below the electric field induction electrode.

At least one of the first grounding electrode and the second grounding electrode may include a first extension part 91a extending in a first direction and a second extension part 91b extending to intersect the first extension part to form a mesh shape with the first extension part.

At least one of the first grounding electrode and the second grounding electrode may include a plate part 91c and a plurality of holes 91d formed on the plate part to allow air introduced into the inside of the housing by the blowing fan to pass through, and the plurality of holes may include at least one of a polygon and a circle.

The discharging electrode may include a plurality of the discharging electrodes 61, the electrostatic precipitator may include a plurality of printed circuit boards 53 configured to be electrically connected to the plurality of discharging electrodes, and the plurality of printed circuit boards may include a first printed circuit board 53a extending in a first direction, and a second printed circuit board 53b extending in the first direction and spaced apart from the first printed circuit board in a second direction different from the first direction.

The plurality of printed circuit boards may further include a third printed circuit board 53d extending in the second direction to connect the first printed circuit board and the second printed circuit board.

The third printed circuit board may be connected to a first end of the second printed circuit board along the first direction, and the plurality of printed circuit boards may further include a fourth printed circuit board 53e connected to a second end of the second printed circuit board along the first direction.

The discharging electrode may include a plurality of the discharging electrodes 61, the electrostatic precipitator may include a plurality of printed circuit boards 53 configured to be electrically connected to the plurality of discharging electrodes, and the plurality of printed circuit boards may include a first printed circuit board 53a including a first board part 53aa extending in a first direction and a second board part 53ab extending from one end of the first board part in a second direction different from the first direction, and a second printed circuit board 53b including a first board part 53ba extending in the first direction and a second board part 53bb extending from one end of the first board part in a third direction opposite to the second direction.

The discharging electrode may include a plurality of the discharging electrodes 61, the electrostatic precipitator may include a printed circuit board 53 configured to be electrically connected to the plurality of discharging electrodes, and the printed circuit board may include a first board part 53aa extending in a first direction, a second board part 53ab spaced apart from the first board part and extending in the first direction, a third board part 53ba extending in a second direction to connect the first board part and the second board part, and a fourth board part 53bb spaced apart from the third board part and extending in the second direction to connect the first board part and the second board part.

The electric field induction electrode may include horizontal portions 71a, 71b, and 71c disposed below the discharging electrode, and protrusion portions 73 protruding from the horizontal portions toward the discharging electrode.

The discharging electrode may include a plurality of the discharging electrodes, the electric field induction electrode may be configured to surround the plurality of discharging electrodes and include a first side 71a, a second side 71b spaced apart from the first side, a third side 71c connecting the first side and the second side between the first side and the second side, and a fourth side 71d opened between the first side and the second side, the electrostatic precipitator may include a plurality of printed circuit boards 53 configured to be electrically connected to the plurality of discharging electrodes, and the plurality of printed circuit boards may include a first printed circuit board 53a adjacent to the first side of the electric field induction electrode and extending in a first direction, a second printed circuit board 53b spaced apart from the first printed circuit board to be adjacent to the second side of the electric field induction electrode and extending in the first direction, and a third printed circuit board 53c adjacent to the third side of the electric field induction electrode and extending in a second direction different from the first direction.

The electric field induction electrode may include an annular shape.

An air conditioner according to an embodiment may include a housing 10, a blowing fan 30 disposed inside the housing and configured to form an air flow, and an electrostatic precipitator 50 accommodated in the housing, wherein the electrostatic precipitator 50 may include dust collecting electrodes 82 and 83 configured to capture aerosols from air introduced into the housing by the blowing fan, a discharging electrode 61 configured to generate ions and positioned below the dust collecting electrodes, a first grounding electrode 91 grounded to form an electric field with the discharging electrode and positioned below the discharging electrode, and a second grounding electrode 91 positioned above the discharging electrode and below the dust collecting electrodes so that the ions are attached thereto.

The discharging electrode may be disposed above the first grounding electrode and below the second grounding electrode, and the electrostatic precipitator may further include a third grounding electrode 92 disposed below the first grounding electrode.

At least one of the second grounding electrode and the third grounding electrode may include a first extension part 91a extending in a first direction, and a second extension part 91b extending to intersect the first extension part to form a mesh shape with the first extension part.

The discharging electrode may include a plurality of the discharging electrodes 61, the electrostatic precipitator may include a plurality of printed circuit boards 53 configured to be electrically connected to the plurality of discharging electrodes, and the plurality of printed circuit boards may further include a first printed circuit board 53a extending in a first direction, and a second printed circuit board 53b extending in the first direction and spaced apart from the first printed circuit board in a second direction different from the first direction.

The plurality of printed circuit boards may further include a third printed circuit board 53c extending in the second direction to connect the first printed circuit board and the second printed circuit board.

The third printed circuit board may be connected to a first end of the second printed circuit board along the first direction, and the plurality of printed circuit boards may further include a fourth printed circuit board 53d connected to a second end of the second printed circuit board along the first direction.

An air conditioner according to an embodiment may include a blowing fan 30, a housing 10 configured to accommodate the blowing fan, including a first side 11a, a second side 11b opposite the first side, a third side 11c between the first side and the second side, and a fourth side 11d opposite the third side between the first side and the second side, and having intake ports 13a and 14 formed on the first side, the second side, the third side, and the fourth side, and an electrostatic precipitator 50 accommodated in the housing, wherein the electrostatic precipitator may include dust collecting electrodes 82 and 83 configured to capture aerosols from air introduced into the housing by the blowing fan, a discharging electrode 61 configured to generate ions toward the intake ports and positioned below the dust collecting electrodes, an electric field induction electrode 71 grounded to form an electric field with the discharging electrode and positioned below the discharging electrode, and a grounding electrode 91 positioned above the discharging electrode and below the dust collecting electrodes.

The grounding electrode may be a first grounding electrode, the discharging electrode may be disposed above the electric field induction electrode and below the first grounding electrode, and the electrostatic precipitator may further include a second grounding electrode 92 disposed below the electric field induction electrode.

The foregoing has illustrated and described specific embodiments. However, it should be understood by those of skilled in the art that the present disclosure is not limited to the above-described embodiments, and various changes and modifications may be made without departing from the technical idea of the present disclosure described in the following claims.

What is claimed is:

1. An air conditioner comprising:
a blowing fan;
a housing configured to accommodate the blowing fan which is configured to introduce air into the housing, the housing comprising:
a first surface;
a second surface opposite the first surface;
a third surface between the first surface and the second surface;
a fourth surface opposite the third surface between the first surface and the second surface; and
a plurality of intake ports formed on each of the first surface, the second surface, the third surface, and the fourth surface; and
an electrostatic precipitator accommodated in the housing,
wherein the electrostatic precipitator comprises:
a dust collecting electrode configured to capture aerosols from the air introduced into the housing by the blowing fan;
a discharging electrode configured to generate ions toward the plurality of intake ports, the discharging electrode positioned upstream of the dust collecting electrode;
an electric field induction electrode grounded to form an electric field with the discharging electrode, the electric field induction electrode positioned upstream of the discharging electrode; and
a grounding electrode positioned downstream of the discharging electrode, the grounding electrode positioned upstream of the dust collecting electrode so that the ions are attached thereto.

2. The air conditioner according to claim 1, wherein
the grounding electrode is a first grounding electrode,
the discharging electrode is disposed above the electric field induction electrode and below the first grounding electrode, and
the electrostatic precipitator further comprises a second grounding electrode disposed below the electric field induction electrode.

3. The air conditioner according to claim 2, wherein
at least one of the first grounding electrode and the second grounding electrode comprises:
a first extension part extending in a first direction; and
a second extension part extending to intersect the first extension part to form a mesh shape with the first extension part.

4. The air conditioner according to claim 2, wherein
at least one of the first grounding electrode and the second grounding electrode comprises:
a plate part; and
a plurality of holes formed on the plate part to allow the air introduced into inside of the housing by the blowing fan to pass through, the plurality of holes having at least one of a polygon and a circle.

5. The air conditioner according to claim 2, wherein
the discharging electrode comprises: a plurality of discharging electrodes,
the electrostatic precipitator comprises: a plurality of printed circuit boards configured to be electrically connected to the plurality of discharging electrodes, and
the plurality of printed circuit boards comprises:
a first printed circuit board extending in a first direction; and
a second printed circuit board extending in the first direction, the second printed circuit board spaced apart from the first printed circuit board in a second direction different from the first direction.

6. The air conditioner according to claim 5, wherein
the plurality of printed circuit boards further comprises: a third printed circuit board extending in the second direction to connect the first printed circuit board and the second printed circuit board.

7. The air conditioner according to claim 6, wherein
the third printed circuit board is connected to a first end of the second printed circuit board along the first direction, and
the plurality of printed circuit boards further comprises: a fourth printed circuit board connected to a second end of the second printed circuit board along the first direction.

8. The air conditioner according to claim 2, wherein
the discharging electrode comprises: a plurality of the discharging electrodes,
the electrostatic precipitator comprises: a plurality of printed circuit boards configured to be electrically connected to the plurality of discharging electrodes, and
the plurality of printed circuit boards comprises:
a first printed circuit board comprising:
a first board part extending in a first direction; and
a second board part extending from one end of the first board part in a second direction different from the first direction; and
a second printed circuit board comprising:
a first board part extending in the first direction; and
a second board part extending from one end of the first board part in a third direction opposite to the second direction.

9. The air conditioner according to claim 2, wherein
the discharging electrode comprises: a plurality of discharging electrodes,
the electrostatic precipitator comprises: a printed circuit board configured to be electrically connected to the plurality of discharging electrodes, and
the printed circuit board comprises:
a first board part extending in a first direction;
a second board part spaced apart from the first board part, the second board part extending in the first direction;
a third board part extending in a second direction to connect the first board part and the second board part; and
a fourth board part spaced apart from the third board part, the fourth board extending in the second direction to connect the first board part and the second board part.

10. The air conditioner according to claim 1, wherein
the electric field induction electrode comprises:
a horizontal portion disposed below the discharging electrode; and
a protrusion portion protruding from the horizontal portion toward the discharging electrode.

11. The air conditioner according to claim 1, wherein
the discharging electrode comprises: a plurality of discharging electrodes,
the electric field induction electrode is configured to surround the plurality of discharging electrodes,
the electric field induction electrode comprises:
a first side;
a second side spaced apart from the first side;
a third side connecting the first side and the second side between the first side and the second side; and
a fourth side being open between the first side and the second side,
the electrostatic precipitator comprises: a plurality of printed circuit boards configured to be electrically connected to the plurality of discharging electrodes, and
the plurality of printed circuit boards comprises:
a first printed circuit board adjacent to the first side of the electric field induction electrode, the first printed circuit board extending in a first direction;
a second printed circuit board spaced apart from the first printed circuit board to be adjacent to the second side of the electric field induction electrode, the second printed circuit board extending in the first direction; and
a third printed circuit board adjacent to the third side of the electric field induction electrode, the third printed circuit board extending in a second direction different from the first direction.

12. The air conditioner according to claim 1, wherein
the electric field induction electrode comprises: an annular shape.

13. An air conditioner comprising:
a housing;
a blowing fan disposed inside the housing, the blowing fan configured to introduce air into the housing; and
an electrostatic precipitator accommodated in the housing,
wherein the electrostatic precipitator comprises:
a dust collecting electrode configured to capture aerosols from air introduced into the housing by the blowing fan;
a discharging electrode configured to generate ions and positioned below the dust collecting electrode;
a first grounding electrode grounded to form an electric field with the discharging electrode and positioned below the discharging electrode; and
a second grounding electrode positioned above the discharging electrode and below the dust collecting electrode so that the ions are attached thereto.

14. The air conditioner according to claim 13, wherein
the discharging electrode is disposed above the first grounding electrode and below the second grounding electrode, and
the electrostatic precipitator further comprises: a third grounding electrode disposed below the first grounding electrode.

15. The air conditioner according to claim 14, wherein
at least one of the second grounding electrode and the third grounding electrode comprises:
a first extension part extending in a first direction; and
a second extension part extending to intersect the first extension part to form a mesh shape with the first extension part.
